(19) United States
(12) Patent Application Publication
(10) Pub. No.: US 2026/0093006 A1
(43) Pub. Date: Apr. 2, 2026

(54) METHOD FOR PRIVACY-PRESERVING UWB LOCALIZATION

(71) Applicant: GM Global Technology Operations LLC, Detroit, MI (US)

(72) Inventors: Jinzhu Chen, Troy, MI (US); Zijun Han, Rochester Hills, MI (US); Chuan Li, Troy, MI (US); Fan Bai, Ann Arbor, MI (US); Aaron Adler, Rochester Hills, MI (US); Amulya Tom, Oshawa (CA); Kristine Pankow, Brighton, MI (US)

(21) Appl. No.: 18/899,152

(22) Filed: Sep. 27, 2024

(51) Int. Cl. G01S 5/02; G01S 13/02; G01S 13/08; H04W 4/029

(52) U.S. Cl. CPC G01S 5/0284; G01S 13/0209; G01S 13/08; H04W 4/029

(57) ABSTRACT

A method for privacy-preserving UWB localization includes receiving, by a virtual ultra-wideband (UWB) sensor, a ranging request from a physical UWB tag. The physical UWB tag is part of a mobile device, such as a smart phone. The method also includes generating, by the virtual UWB sensor, a unique identifier in response to receiving the ranging request. The unique identifier collectively identifies a plurality of physical UWB anchors. Each of the plurality of physical UWB anchors is part of a vehicle. The method further includes communicating the unique identifier to the UWB tag. Also, the method includes establishing a communication between the physical UWB tag and the virtual UWB sensor in response to receiving the unique identifier by the UWB tag. The method also includes commanding, by the virtual UWB sensor, at least one of the plurality of physical UWB anchors to activate.

### INTRODUCTION

The present disclosure relates to systems and methods for privacy-preserving UWB localization.

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

The UWB technology is increasingly applied to localization-based applications. It uses highly accurate UWB ranging capability to provide centimeter level localization accuracy to track the devices to provide value-added services and applications. However, this highly accurate location information may be exploited by the malicious applications to attack user's privacy, such as getting the very detailed location where the device visited. It is therefore desirable to develop a privacy-preserving UWB-based localization technique to provide accurate localization of the device for the hosting system (e.g., vehicle or infrastructure) while preventing such accurate localization information to be used by malicious or any unauthorized application on the device.

### SUMMARY

The present disclosure describes a method and system for privacy-preserving UWB localization. The system uses a virtualized sensor randomization, where the localization can be inferred and calculated on the hosting system (e.g., vehicle or infrastructure). However, the malicious/unauthorized applications on the device will only be able to receive randomized ranging information, which are inadequate to infer the exact location of the device with respect to the hosting system. In an aspect of the present disclosure, the method includes receiving, by a virtual ultra-wideband (UWB) sensor, a ranging request from a physical UWB tag. The physical UWB tag is part of a mobile device, such as a smart phone. The method also includes generating, by the virtual UWB sensor, a unique identifier in response to receiving the ranging request. The unique identifier collectively identifies a plurality of physical UWB anchors. Each of the plurality of physical UWB anchors is part of a vehicle. The method further includes communicating, by the virtual UWB sensor, the unique identifier to the UWB tag. Also, the method includes establishing a communication between the physical UWB tag and the virtual UWB sensor in response to receiving the unique identifier by the UWB tag. The method also includes commanding, by the virtual UWB sensor, at least one of the plurality of physical UWB anchors to activate in response to establishing communication between the virtual UWB sensor and the physical UWB tag. The method also includes performing double-sided two-way ranging (DS0-TWR) between the UWB tag and the at least one of the plurality of physical UWB anchors that has been activated to locate the mobile device relative to the vehicle. The method descried in this paragraph improves UWB ranging technology by providing accurate localization of a mobile device for a hosting system (e.g., vehicle), while preventing such accurate localization information to be used by malicious or any unauthorized application on the mobile device, thereby preserving the privacy of the localization information.

In some aspects of the present disclosure, the unique identifier is a media access control (MAC) address. The unique identifier is one of many unique identifiers. Thus, the first unique identifier may be a MAC address, and a second unique identifier may be a scrambled timestamp sequence (STS). The method may include generating an activating schedule for the physical UWB anchors based on a plurality of distances from the physical UWB tag to each of the physical UWB anchors. The method may include randomly assigning the unique identifier to a subset of the physical UWB anchors. The method may include activating the subset of physical UWB anchors and deactivating the remaining physical UWB anchors based on the plurality of distances from the physical UWB tag to each of the physical UWB anchors.

The present disclosure also describes a system for Ultra-wideband (UWB) UWB localization. The system includes physical UWB anchors and a physical UWB tag. The physical UWB anchors are part of a vehicle, and the physical UWB is part of a mobile device. The system further includes a controller that runs a virtual UWB sensor. The controller is programmed to execute the method described above.

The present disclosure also describes a tangible, non-transitory, machine-readable medium, including machine-readable instructions, that when executed by a processor, cause the processor to execute the method described above.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic diagram of a vehicle including a system for privacy-preserving UWB localization.

FIG. 2 is a flowchart of a method for privacy-preserving UWB localization.

FIG. 3 is a flowchart of a method for virtual UWB scheduling.

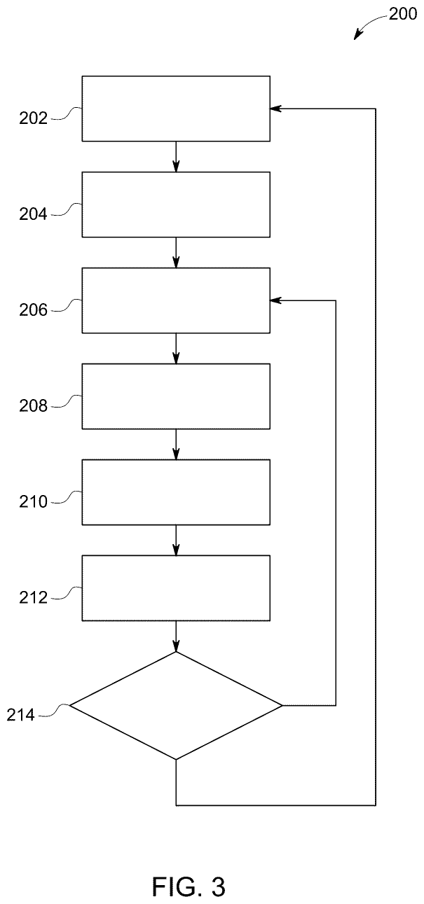

FIG. 4 is a flowchart of a method for random addressing.

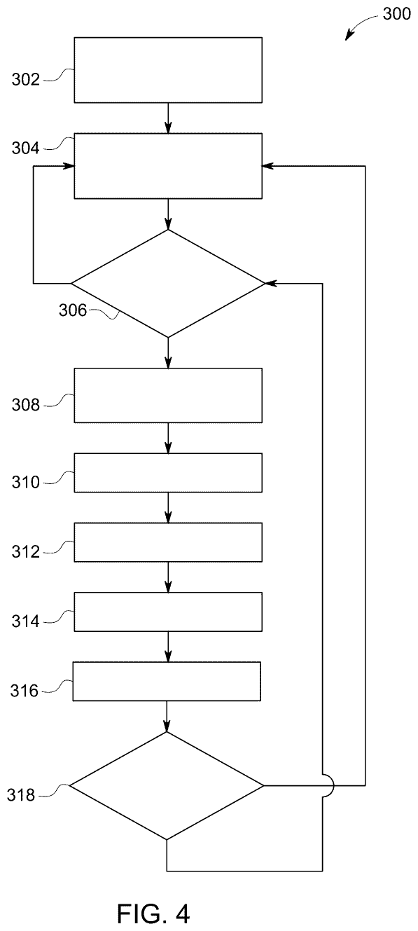

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps.

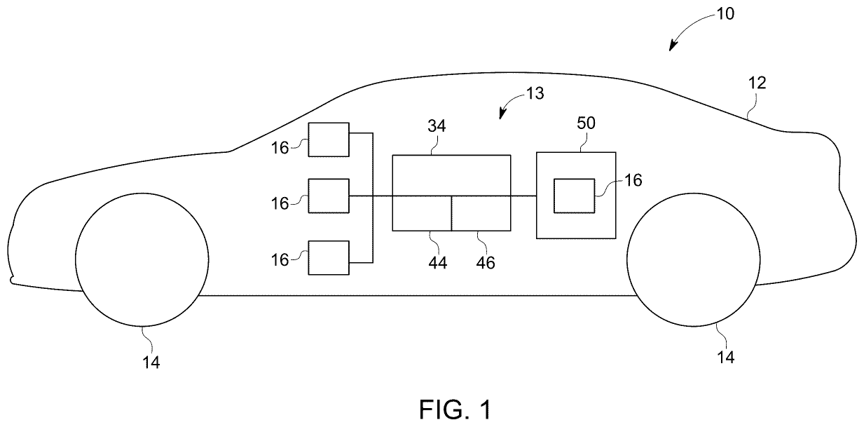

With reference to FIG. 1, a vehicle 10 generally includes a body 12 and a plurality of wheels 14 coupled to the body 12. The body 12 defines a passenger compartment. The vehicle 10 may be an autonomous vehicle. In the depicted embodiment, the vehicle 10 may be a sedan, a truck, a coupe, a sport utility vehicle (SUV), a recreational vehicles (RV).

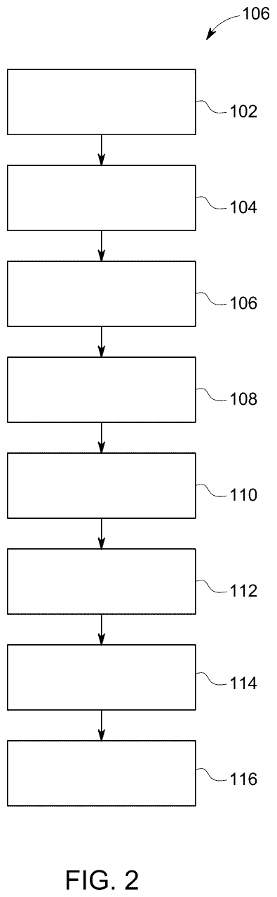

A system 13 may be part or work together with the vehicle 10. The system 13 may be referred to as a system for privacy-preserving for UWB localization and may include a controller 34, such. The controller 34 includes at least one processor 44 and a non-transitory computer readable storage device or media 46. The processor 44 may be a custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, a combination thereof, or generally a device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 34 in controlling the vehicle 10. The controller 34 runs a virtual UWB sensor and is specifically programmed to execute a method 100 (FIG. 2) as described in detail below. While the system 13 is shown in the vehicle 10, the system 13 may alternatively be part of another hosting system, such as infrastructure.

The instructions may include one or more separate programs, each of which comprises an ordered listing of executable instructions for implementing logical functions. The instructions, when executed by the processor 44, receive and process signals from sensors, perform logic, calculations, methods and/or algorithms for automatically controlling the components of the vehicle 10, and generate control signals to automatically control the components of the vehicle 10 based on the logic, calculations, methods, and/or algorithms.

The vehicle 10 further includes a plurality of ultra-wideband (UWB) sensors 16 coupled to the body 12. The UWB sensors 16 that are coupled to the vehicle 10 serve as UWB anchors and are therefore in a fixed position relative to the vehicle 10. Specifically, the UWB sensors 16 that are coupled to the vehicle 10, such that these UWB sensors 16 remain stationary relative to the vehicle 10. Any suitable fastener, such as screws, bolts, among others, may be used to fix the UWB sensors 16 to the body 12. Each of the UWB sensors 16 may be configured as chipsets including a UWB transceiver. The UWB sensors 16 are in communication with the controller 34 and use two-way ranging to locate a mobile device 50. The mobile device 50 includes an UWB sensor 16 that serves as a UWB tag. The UWB sensor 16 of the mobile device 50 may be configured as a chipset including an UWB transceiver. The mobile device 50 may be smart phone, a tablet, a key fob, or any other device that is not physically connected to the vehicle 10 and includes the UWB sensor 16. In the present disclosure, the term “mobile device” is a piece of portable electronic equipment that can communicate with another device at least through UWB signals. The UWB sensor 16 that functions as a UWB tag initializes the ranging message, calculates the distance between the UWB tag and each of the UWB anchors, and publishes these distances and the location information in real-time. The UWB anchors listen to the UWB signals transmitted by the UWB tags and provides feedback. In the depicted embodiment, the UWB sensors 16 that are fixed to the body 12 are referred to as physical UWB anchors, whereas the UWB sensor 16 that is part of the mobile device 50 is referred to as a physical UWB tag.

FIG. 2 is a flowchart of a method 100 for privacy-preserving UWB localization. The method 100 begins at block 102. At block 102, the physical UWB tag (i.e., the UWB sensor 16 that is part of the mobile device 50) sends a ranging request to the virtual sensor that is running in the controller 34. The physical UWB tag may be in wireless communication with the controller 34 through a wireless network, such as a BLUETOOTH LOW ENERGY (BLE) wireless network. The physical UWB tag is wirelessly connected to the controller 34 (and therefore the virtual UWB sensor) through a secured wireless channel. Then, the method 100 continues to block 104.

At block 104, the virtual UWB sensor generates a first unique identifier, such as Media Access Control (MAC) address or a short MAC address (SMAC) in response to receiving the ranging request from the mobile device 50. At block 104, the virtual UWB sensor may also generate a raging session key. The method 100 then continues to block 106.

At block 106, the virtual UWB sensor sends the unique identifier (e.g., MAC address) and the raging session key to the physical UWB tag. Then, the method 100 continues to block 108.

At block 108, the virtual UWB sensor negotiates with the mobile device 50 and a secured ranging session is established between the UWB tag and the virtual UWB sensor. Then, the method 100 continues to block 110.

At block 110, the virtual UWB sensor derives a scrambled timestamp sequence (STS) index from the ranging session key. Then, the virtual UWB sensor generates an STS based on the STS index. Next, the method 100 continues to block 112.

At block 112, the virtual UWB sensor distributes the unique identifier (e.g., MAC address or short MAC address), STS, and a wakeup schedule to the physical UWB anchors. Then, the method 100 continues to block 114.

At block 114, at least one of the physical UWB anchors activates based on the wakeup schedule. Then, the method 100 continues to block 116.

At block 116, a double-sided two-way ranging (DS-TWR) between the physical UWB tag and the at least one of the physical UWB anchors that has been activated to locate the mobile device 50 relative to the vehicle 10.

The present disclosure also describes a method 200 for virtual UWB scheduling. The method 200 schedules the UWB communication of each individual physical UWB sensors 16 to communicate with the mobile device 50 and begins at block 202. Then controller 34 is programmed to execute the method 200. At block 202, the controller 34 updates the UWB sensor 16 schedule according to an initial predetermined order or a later-provided order. Then, the method 200 continues to block 204.

At block 204, the controller 34 updates the unique identifier (e.g., MAC address or SMAC) and the STS for each ranging slot. Then, the method 200 proceeds to block 206. At block 206, the double-sided two-way ranging (DS-TWR) between the UWB tag and the at least one physical UWB anchors that has been activated is performed. It is envisioned that multiple ranging session may be performed with the UWB tag and several UWB anchors. Each ranging session produces ranging data. Then, the method 200 continues to block 208. At block 208, the mobile device 50 is localized relative to the vehicle 10 (or infrastructure) using the raging data and tracking is initialized. The controller 34 also predicts the location of the mobile device 50 for the current timestamp using Bayesian Tracking. Then, the method 200 proceeds to block 210.

At block 210, the distances between the UWB tag and each of the UWB anchors that was active is determined. Next, the method 200 continues to block 212. At block 212, three or more UWB anchors with similar distances (e.g., distances that are ±five percent from each other) are selected. For example, the controller 34 may rank these distance measurements and identify the three UWB anchors with closest measurements and lowest variance among each three adjacent sensors based on the measurements. The virtual UWB sensor activates the three selected anchors and deactivates all others UWB anchors for distance measurements. Next, the method 200 continues to block 214. At block 214, the controller 34 determines if the UWB anchor set selected at block 212 has to be updated. For example, the UWB anchor set may have to be updated based on the movement of the mobile device 50 relative to the vehicle 10. If no UWB anchor set update is necessary, then the method 200 returns to block 206. If an UWB anchor set update is needed, then the method 200 returns to block 202.

The present disclosure also describes a method 300 for random addressing. The method 300 may be executed by the controller 34 and begins at block 302. At block 302, the virtual UWB sensor negotiates with the mobile device 50 to establish a connection between the controller 34 and the mobile device 50. Then, the method 300 continues to block 304. At block 304, the virtual UWB sensor distributes a tuple (e.g., STS, STS index, SMAC, and/or MAC) to the physical UWB anchors. Then, the method 300 continues to block 306. At block 306, the controller 34 determines whether a node is in the active set of physical UWB anchors. If the node is not in the active set of physical UWB anchors, then the method 300 returns to block 304. If the node is in the active set of physical UWB anchors, then the method 300 continues to block 308. At block 308, the virtual UWB sensor updates the STS. Next, the method 300 continues to block 310.

At block 310, the double-sided two-way ranging (DS-TWR) between the UWB tag and the at least one physical UWB anchors that has been activated is performed. It is envisioned that multiple ranging session may be performed with the UWB tag and several UWB anchors. Each ranging session produces ranging data. Then, the method 300 continues to block 312. At block 312, the mobile device 50 is localized relative to the vehicle 10 (or infrastructure) using the raging data and tracking is initialized. The controller 34 also predicts the location of the mobile device 50 for the current timestamp using Bayesian Tracking. Then, the method 300 proceeds to block 314.

At block 314, the distances between the UWB tag and each of the UWB anchors that was active is determined. Next, the method 300 continues to block 316. At block 316, three or more UWB anchors with similar distances (e.g., distances that are ±five percent from each other) are selected. For example, the controller 34 may rank these distance measurements and identify the three UWB anchors with closest measurements and lowest variance among each three adjacent sensors based on the measurements. The virtual UWB sensor activates the three selected anchors and deactivates all others UWB anchors for distance measurements. Next, the method 300 continues to block 318. At block 318, the controller 34 determines if the UWB anchor set selected at block 316 has to be updated. For example, the UWB anchor set may have to be updated based on the movement of the mobile device 50 relative to the vehicle 10. If no UWB anchor set update is necessary, then the method 300 returns to block 304. If an UWB anchor set update is needed, then the method 300 returns to block 306.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the presently disclosed system and method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

Embodiments of the present disclosure are described herein. It is to be understood, however, that the disclosed embodiments are merely examples and other embodiments can take various and alternative forms. The figures are not necessarily to scale; some features could be exaggerated or minimized to display details of particular components. Therefore, specific structural and functional details disclosed herein are not to be interpreted as limiting, but merely as a representative basis for teaching one skilled in the art to variously employ the presently disclosed system and method. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for privacy-preserving UWB localization, comprising:
receiving, by a virtual Ultra-wideband (UWB) sensor, a ranging request from a physical UWB tag, wherein the physical UWB tag is part of a mobile device;
in response to receiving the ranging request, generating, by the virtual UWB sensor, a unique identifier, wherein the unique identifier identifies a plurality of physical UWB anchors, and each of the plurality of physical UWB anchors is part of a vehicle;
communicating, by the virtual UWB sensor, the unique identifier to the UWB tag;
in response to receiving the unique identifier by the UWB tag, establishing a communication between the physical UWB tag and the virtual UWB sensor;
in response to establishing communication between the virtual UWB sensor and the physical UWB tag, commanding, by the virtual UWB sensor, at least one of the plurality of physical UWB anchors to activate; and
performing double-sided two-way ranging (DS-TWR) between the UWB tag and the at least one of the plurality of physical UWB anchors that has been activated to locate the mobile device relative to the vehicle.

2. The method of claim 1, wherein the unique identifier is a Media Access Control (MAC) address.

3. The method of claim 2, wherein the unique identifier is a first unique identifier of a plurality of unique identifiers.

4. The method of claim 3, wherein the plurality of unique identifiers includes a scrambled timestamp sequence (STS).

5. The method of claim 4, further comprising generating an activating schedule for the plurality of physical UWB anchors based on a plurality of distances from the physical UWB tag to each of the plurality of physical UWB anchors.

6. The method of claim 5, further comprising randomly assigning the unique identifier to a subset of the physical UWB anchors.

7. The method of claim 6, further comprising activating the subset of physical UWB anchors and deactivating a remaining of the physical UWB anchors based on the plurality of distances from the physical UWB tag to each of the physical UWB anchors.

8. A system for Ultra-wideband (UWB) UWB localization, comprising:
a plurality of physical UWB anchors, wherein the plurality of physical UWB anchors is part of a vehicle;
a physical UWB tag, wherein the physical UWB tag is part of a mobile device;
a controller in communication with the plurality of physical UWB anchors and the UWB tag, wherein the controller runs a virtual UWB sensor, and the controller is programmed to:
receive, by the virtual UWB sensor, a ranging request from a physical UWB tag, wherein the physical UWB tag is part of a mobile device;
in response to receiving the ranging request, generate, by the virtual UWB sensor, at least one unique identifier, wherein the unique identifier identifies the physical UWB anchors, wherein the physical UWB anchors are part of a vehicle;
communicate, by the virtual UWB sensor, the at least one unique identifier to the UWB tag;
in response to receiving the at least one unique identifier by the UWB tag, establish a communication between the physical UWB tag and the virtual UWB sensor;
in response to establishing communication between the virtual UWB sensor and the physical UWB tag, command, by the virtual UWB sensor, at least one of the physical UWB anchors to activate; and
perform double-sided two-way ranging (DS-TWR) between the UWB tag and the at least one of the physical UWB anchors that has been activated to locate the mobile device relative to the vehicle.

9. The system of claim 8, wherein the at least one unique identifier is a Media Access Control (MAC) address.

10. The system of claim 9, wherein the at least one unique identifier is a first unique identifier of a plurality of unique identifiers.

11. The system of claim 10, wherein the plurality of unique identifiers includes a scrambled timestamp sequence (STS).

12. The system of claim 11, wherein the controller is programmed to generate an activating schedule for the plurality of physical UWB anchors based on a plurality of distances from the physical UWB tag to each of the physical UWB anchors.

13. The system of claim 12, wherein the controller is programmed to randomly assign the unique identifier to a subset of the plurality of physical UWB anchors.

14. The system of claim 13, wherein the controller is programmed to activating the subset of physical UWB anchors and deactivating a remaining of the physical UWB anchors based on the plurality of distances from the physical UWB tag to each of the physical UWB anchors.

15. A tangible, non-transitory, machine-readable medium, comprising machine-readable instructions, that when executed by a processor, cause the processor to:
receive, by a virtual UWB sensor, a ranging request from a physical UWB tag, wherein the physical UWB tag is part of a mobile device;
in response to receiving the ranging request, generate, by the virtual UWB sensor, a unique identifier, wherein the unique identifier identifies a plurality of physical UWB anchors, wherein each of the plurality of physical UWB anchors is part of a vehicle;
communicate, by the virtual UWB sensor, the unique identifier to the UWB tag;
in response to receiving the unique identifier by the UWB tag, establish a communication between the physical UWB tag and the virtual UWB sensor;
in response to establishing communication between the virtual UWB sensor and the physical UWB tag, command, by the virtual UWB sensor, at least one of the plurality of physical UWB anchors to activate; and
perform double-sided two-way ranging (DS-TWR) between the UWB tag and the at least one of the plurality of physical UWB anchors that has been activated to locate the mobile device relative to the vehicle.

16. The tangible, non-transitory, machine-readable medium of claim 15, wherein the unique identifier is a Media Access Control (MAC) address.

17. The tangible, non-transitory, machine-readable medium of claim 15 wherein the unique identifier is a first unique identifier of a plurality of unique identifiers.

18. The tangible, non-transitory, machine-readable medium of claim 17, wherein the plurality of unique identifiers includes a scrambled timestamp sequence (STS).

19. The tangible, non-transitory, machine-readable medium of claim 8, wherein the tangible, non-transitory, machine-readable medium, further comprising machine-readable instructions, that when executed by the processor, causes the processor to generate an activating schedule for the plurality of physical UWB anchors based on a plurality of distances from the physical UWB tag to each of the physical UWB anchors.

20. The tangible, non-transitory, machine-readable medium of claim 8, wherein the tangible, non-transitory, machine-readable medium, further comprising machine-readable instructions, that when executed by the processor, causes the processor to randomly assign the unique identifier to a subset of the physical UWB anchors.
